(19) United States
(12) Patent Application Publication
(10) Pub. No.: US 2002/0108690 A1
(43) Pub. Date: Aug. 15, 2002

(54) Tire structure

(76) Inventor: Yu-Ren Liu, Chang-Hua Hsien (TW)

Correspondence Address: Charles E. Baxley, Esq., 5th Floor, 59 John Street, New York, NY, 10038, US

(21) Appl. No.: 09/781,209

(22) Filed: Feb. 12, 2001

(51) Int. Cl. B60C 5/00

(52) U.S. Cl. 152/429

(57) ABSTRACT

A tire structure includes a hole defined through a sidewall of the tire and a flexible valve is inserted in the hole. A passage is defined longitudinally through the flexible valve and the flexible valve is deformed by the sidewall so as to seal the passage.

### FIELD OF THE INVENTION

The present invention relates to a tire structure having a flexible plastic valve whose passage can be sealed by the pressure form the sidewall of the tire.

### BACKGROUND OF THE INVENTION

A conventional tire for scooters or strollers is shown in FIG. 5 and generally includes a solid tire engaged with a wheel rim 11. The solid tire is generally made from EVA or PU. Although PU has better flexibility and is easily steered, the material tends to be deformed permanently and therefore is disengaged from the ring 11. It is too stiff for the EVA and tends to be worn out so that the EVA tire cannot be satisfied by the customers. If the tire is made from rubber which is too heavy. Therefore, the small tires used on scooters or strollers need inflatable tires. The conventional inflatable tires involve more parts and are expensive which is the last factor that the tires need.

The present invention intends to provide a inflatable tire structure that has a flexible valve extending through the sidewall of the tire and the valve is sealed by the pressure of the sidewall.

### SUMMARY OF THE INVENTION

In accordance with one aspect of the present invention, there is provided a tire structure and comprising a hole defined through a sidewall of the tire and a flexible valve is inserted in the hole. A first passage is defined longitudinally through the flexible valve. The flexible valve is deformed by the sidewall so as to seal the first passage.

The primary object of the present invention is to provide a tire that has a flexible valve which can be squeezed by the sidewall of the tire to seal the passage in the valve.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a cross sectional view to show a tire structure of the present invention;

FIG. 2 is a cross sectional view to show an inflation needle inserted in the passage of the flexible valve as shown in FIG. 1;

FIG. 3 is a cross sectional view to show another embodiment of the flexible valve engaged with the sidewall of the tire of the present invention;

FIG. 4 is a cross sectional view to show an inflation needle inserted in the passage of the flexible valve as shown in FIG. 3;

FIG. 4 is a cross sectional view to show another embodiment of the flexible valve engaged with the sidewall of the tire structure of the present invention, and

FIG. 5 is a perspective view to show a conventional solid tire.

### DETAILED DESCRIPTION OF THE PREFERRED EMBODIMENTS

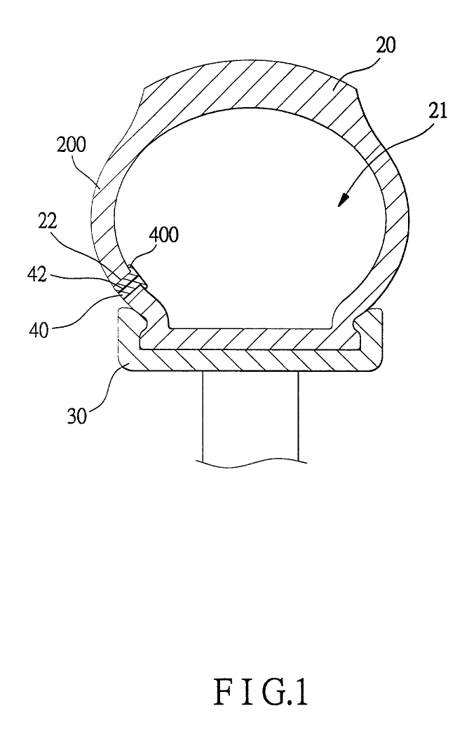

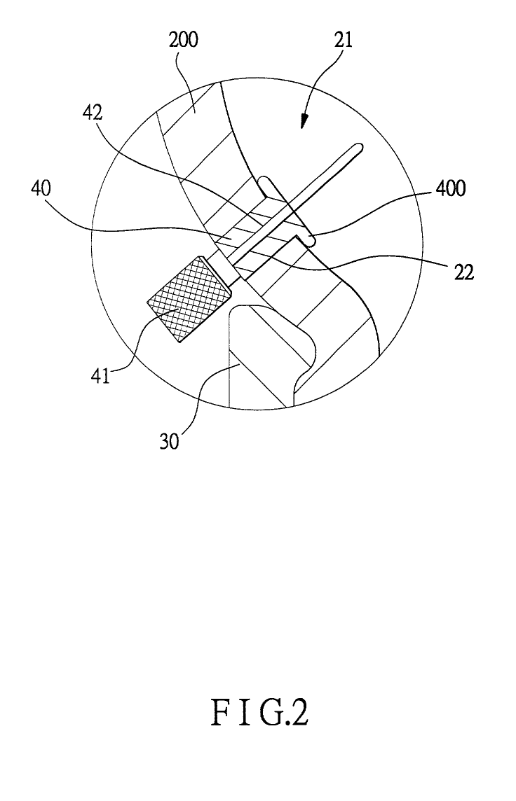

Referring to FIGS. 1 and 2, the tire structure of the present invention is engaged with a wheel rim 30 and comprises a hole 22 defined through a sidewall 200 of the tire 20 and a flexible valve 40 is inserted in the hole 22. A flange 400 extends from radially outward from the flexible valve 40 and is engaged with an inner periphery of the tire 20 so that the flexible valve 40 will not be disengaged from the tire 20. A first passage 42 is defined longitudinally through the flexible valve 40 and the flexible valve 40 is deformed by a pressure of the sidewall 200 from a periphery defining the hole 22 as to seal the first passage 42. By this way, the air in the space 21 enclosed by the tire 20 and the wheel rim 30 will not elapse. When an inflation needle 41 is inserted into the first passage 42, the space communicates with the outside of the tire 20, and air can be entered into the space 21 via the inflation needle 41.

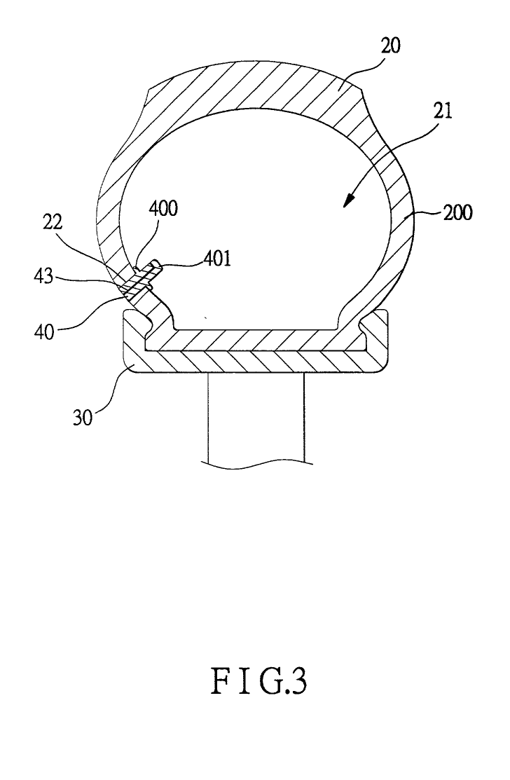

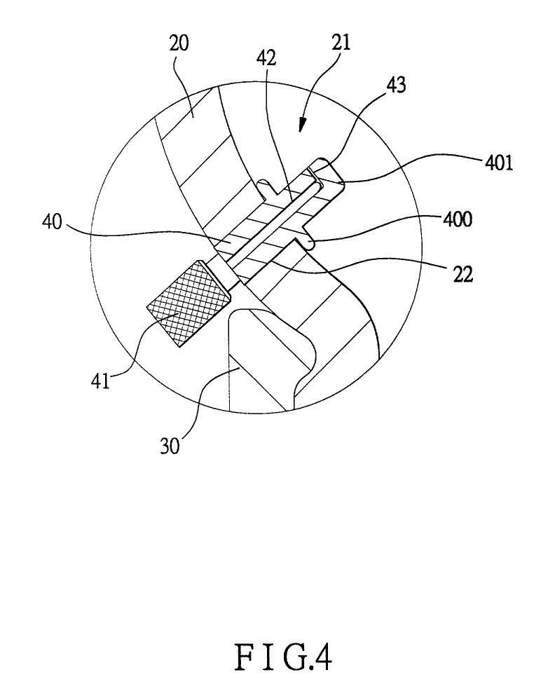

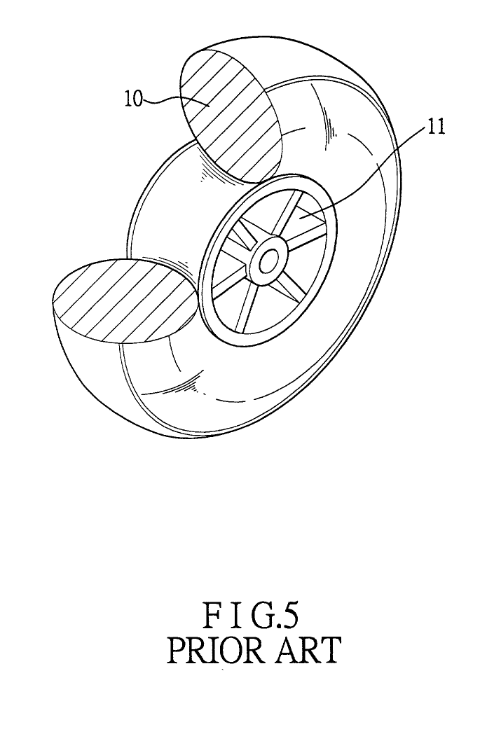

FIGS. 3 and 4 show another embodiment of the present invention wherein an extension portion 401 extends from the flange 400 and a second passage 43 is defined radially in the extension portion 401 of the flexible valve 40. The second passage 43 communicates with the first passage 42.

While we have shown and described various embodiments in accordance with the present invention, it should be clear to those skilled in the art that further embodiments may be made without departing from the scope and spirit of the present invention.

What is claimed is:

1. A tire structure comprising:
a hole defined through a sidewall of said tire and said tire engaged with a wheel rim, and
a flexible valve inserted in said hole and a first passage defined longitudinally through said flexible valve, said flexible valve being deformed by said sidewall so as to seal said first passage.

2. The tire structure as claimed in claim 1 further comprising a second passage defined radially in said flexible valve and communicating with said first passage.

3. The tire structure as claimed in claim 1 further comprising a flange extending from radially outward from said flexible valve and engaged with an inner periphery of said tire.

4. The tire structure as claimed in claim 2 further comprising a flange extending from radially outward from said flexible valve and engaged with an inner periphery of said tire, an extension portion extending from said flange and a second passage defined radially in said extension portion, said second passage communicating with said first passage.
